(19) United States
(12) Patent Application Publication
(10) Pub. No.: US 2019/0295181 A1
(43) Pub. Date: Sep. 26, 2019

(54) COMPUTER-BASED IDENTIFICATION AND VALIDATION OF DATA ASSOCIATED WITH REAL ESTATE PROPERTIES

(71) Applicant: CoreLogic Solutions, LLC, Irvine, CA (US)

(72) Inventors: Robert Gill, Irvine, CA (US); Jeff MacCarron, Irvine, CA (US); Mangesh Risbud, Irvine, CA (US); Richard Terbrack, Irvine, CA (US)

(21) Appl. No.: 16/281,919

(22) Filed: Feb. 21, 2019

Related U.S. Application Data
(63) Continuation of application No. 14/020,132, filed on Sep. 6, 2013, now abandoned.

(51) Int. Cl. G06Q 40/00; G06Q 50/16

(52) U.S. Cl. CPC G06Q 40/10; G06Q 50/16

(57) ABSTRACT

Computer-based systems and methods are disclosed for automatically identifying and validating information associated with real estate properties using data aggregated from multiple sources. The systems and methods can automatically identify the tax agency and/or tax identifier for real estate properties without substantial user interaction. In some embodiments, the systems and methods can automatically identify the real estate property and/or parcel based at least in part on received tax information without substantial user interaction. A confidence score and/or error rate may also be calculated based on one or more rules to provide information about the relative error rate in any of the identifications provided.

### RELATED APPLICATIONS

This application is a continuation of U.S. application Ser. No. 14/020,132, filed Sep. 6, 2013, the disclosure of which is hereby incorporated by reference.

### BACKGROUND

### Field

The present disclosure relates to computer processes for automatically identifying data items for real estate properties.

### Description of the Related Art

When a financial institution such as a bank makes a loan to enable a borrower to buy real property, the financial institution generally acquires a lien (e.g., a mortgage) on the property to secure the loan. If the borrower defaults on the loan, the lender can foreclose on the property to mitigate the lender's loss from the default.

Governmental entities such as counties, school districts, and municipalities may also have liens on a property if taxes due on the property have not been paid. In addition, other parties may acquire interests in real properties after tax defaults through mechanisms such as tax sales and foreclosures. Therefore, a mortgage lender typically monitors tax payment and delinquencies, as well as related actions by tax authorities, to ensure that the lender's interests in properties securing their loans are not compromised.

Real property mortgage lenders often engage service providers to advise the lenders of the status of property tax payments due on real estate securing their loans. In addition to monitoring tax payment status, service providers may provide a variety of other tax-related services to lenders. For example, where a mortgage lender requires that tax payments be impounded on behalf of borrowers, a service provider may monitor and oversee the transfer of monies to the taxing authorities and provide confirmation to the lender that the taxes have been paid.

A service provider's lender customers may have a large number of loans secured by real properties in a multitude of locations. A large service provider will thus need to monitor tax payment and delinquency status for a multitude of taxing authorities (e.g., county tax collectors, school districts) nationwide. Service providers generally perform their services using a combination of automated systems and manual activities.

As the number of loans being serviced by a service provider increases, the demands on human resources may become substantial. Moreover, as the number of loans being serviced by a service provider increases, the requirements for accuracy and quality control can also become challenging.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 is a block diagram that schematically illustrates an example of a system to automatically identify data items for real estate properties.

FIG. 2 is a flowchart illustrating a method of identifying tax information associated with real estate properties in accordance with an embodiment.

FIG. 3 is a block diagram that schematically illustrates an example of one or more types of identifiers associated with real estate properties that may be utilized in a system to automatically identify data items for real estate properties.

FIG. 4 is a flowchart that illustrates an example of a method for identifying property information associated with real estate properties in accordance with an embodiment.

FIG. 5 is a flowchart illustrating an example of a method for automatically identifying tax information associated with real estate properties without substantial user interaction in accordance with an embodiment.

FIG. 6 is a block diagram that schematically illustrates an example of one or more factors that can be considered by one or more business rules that may be included in a system to automatically identify data items for real estate properties.

FIG. 7 is a flowchart illustrating an example of a method for automatically identifying property information associated with real estate properties without substantial user interaction in accordance with an embodiment.

FIG. 8 is a flowchart illustrating an example of a method for automatically identifying government agency information associated with real estate properties without substantial user interaction in accordance with an embodiment.

FIG. 9 is a flowchart illustrating another example of a method for automatically identifying property information associated with real estate properties without substantial user interaction in accordance with an embodiment.

### DETAILED DESCRIPTION

Various aspects of the disclosure will now be described with regard to certain examples and embodiments, which are intended to illustrate but not to limit the disclosure.

Computer-based systems and methods are disclosed for automatically identifying data items, such as taxes, for real estate properties. In some embodiments, the systems and methods can automatically identify the tax agency and/or tax identifier for real estate properties without substantial user interaction. In some embodiments, the systems and methods can automatically identify the real estate property and/or parcel based at least in part on received tax information without substantial user interaction. In some embodiments, the systems and methods can automatically identify government agency information for real estate properties without substantial user interaction. In some embodiments, the systems and methods can automatically identify the real estate property and/or parcel based at least in part on received government agency information without substantial user interaction. In some embodiments, a confidence score and/or error rate may be calculated to provide information about the relative error rate in any of the identifications provided.

Implementations of the disclosed systems and methods will be described in the context of data processing for real estate properties. This is for purposes of illustration and is not a limitation. For example, implementations of the disclosed systems and methods can be used for data processing for commercial property developments such as office complexes, industrial, or warehouse complexes, retail and shopping centers, apartment rental complexes. Similarly, implementations of the disclosed systems and methods can be used for data processing for any type property that is reviewed by administrative or government agencies.

### Example Services System

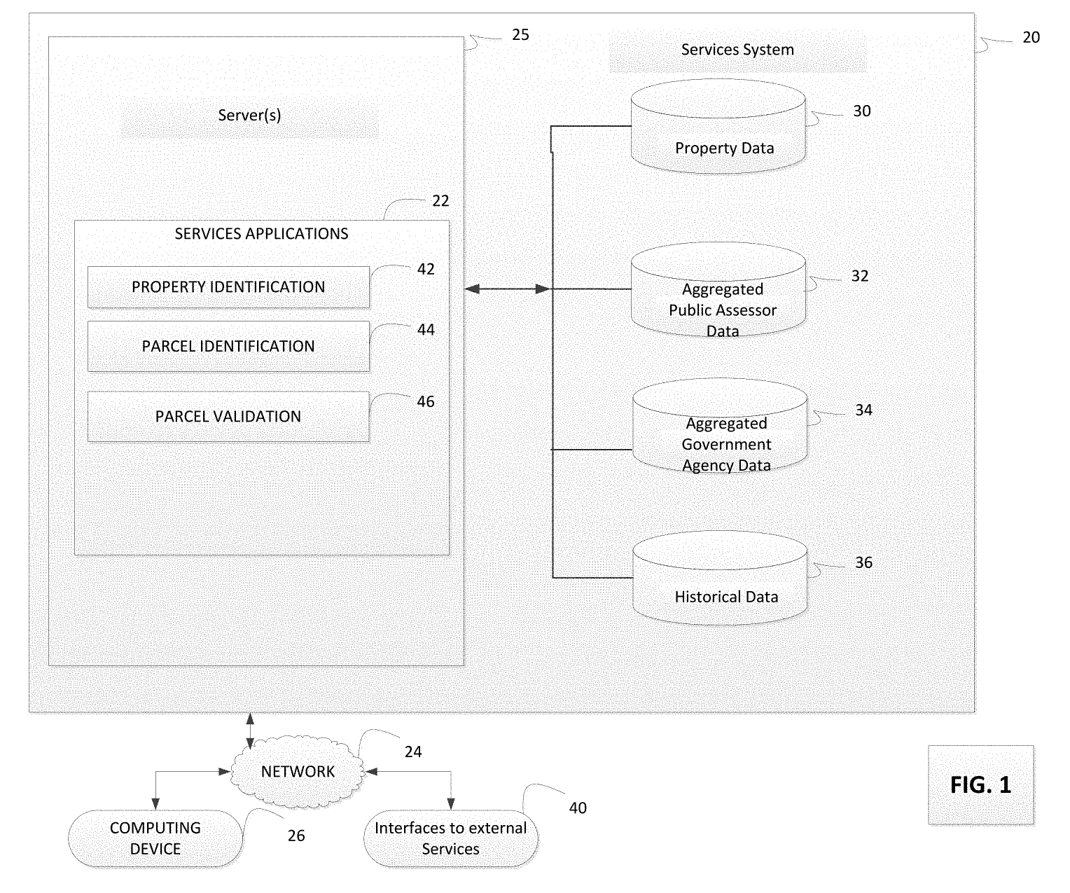

FIG. 1 illustrates an analytics system 20 according to one embodiment. The system may be provided by a business entity or “services provider” that provides various services to its customers, such as for assessing taxes, associated with real estate properties. As illustrated, the system includes a set of services applications 22 that are accessible over a network 24 (such as the Internet) via a computing device 26 (desktop computers, mobile phones, servers, etc.). Typical customers of the system 20 include mortgage lenders, other types of lenders, mortgage servicers, real estate investors, and property insurance companies.

As illustrated, services applications 22 use a set of data repositories 30-36 to perform various types of service tasks, including tasks associated with tax assessments. In the illustrated embodiment, these data repositories 30-36 include a database of property data 30, a database of aggregated public assessor data 32, a database of aggregated government agency data 34, and a database of historical data 36. Although depicted as separate databases, some of these data collections may be merged into a single database or distributed across multiple distinct databases. Further, additional databases containing other types of information may be maintained and used by the services applications 22. As shown in FIG. 1, each services application 22 runs on one or more physical servers 25 or other computing devices.

The property database 30 contains property data obtained from one or more of the entities that include property data associated with real estate properties. This data may include the type of property (single family home, condo, etc.), the sale price, and some characteristics that describe the property (beds, baths, square feet, etc.). These types of data sources can be found online. For example, multiple listing services (MLSs) contain data intended for realtors, and can be contacted and queried through a network such as the Internet. Such data may then be downloaded for use by embodiments of the present invention. Other examples include retrieving data from databases/websites such as Redfin, Zillow, etc. that allow users to directly post about available properties. Furthermore, property database 30 may contain aggregated data collected from public recorder offices in various counties throughout the United States. This database 30 can include property ownership information and sales transaction histories with buyer and seller names, obtained from recorded land records (grant deeds, trust deeds, mortgages, other liens, etc.). In one embodiment, the services provider maintains this database 30 by purchasing or otherwise obtaining public record documents from most or all of the counties in the United States (from the respective public recorders offices), and by converting those documents (or data obtained from such documents) to a standard format. Such a database is maintained by CoreLogic, Inc. The property database 30 is preferably updated on a daily or near-daily basis so that it closely reflects the current ownership statuses of properties throughout the United States. In one implementation, the database 30 covers 97% of the sales transactions from over 2,535 counties.

The public assessor database 32 shown in FIG. 1 contains aggregated tax roll data, including land files and assessment information, collected from the public assessor offices in various counties throughout the United States. This data includes, among other items, the mailing addresses of record for contacting home owners, for example to mail property tax bills. In one embodiment, the services provider maintains the database of public assessor data 32 by purchasing or otherwise obtaining public assessor data from most or all counties (public assessor offices) throughout the United States, and by converting this data into a standard format. In one implementation, the public assessor database 32 covers 99% of properties in the United States, including over 146 million parcels in more than 3,100 counties. Such a database is maintained by CoreLogic, Inc. The government agency database 34 shown in FIG. 1 contains aggregated government agency data collected from the government agency offices in various counties throughout the United States. In one embodiment, the services provider maintains the database of government agency data 34 by purchasing or otherwise obtaining government agency data from most or all counties throughout the United States, and by converting this data into a standard format. The historical database 36 shown in FIG. 1 contains aggregated historical transactions data. In one embodiment, the services provider maintains the database of historical data 36 by obtaining historical tax records, contracts, requests, etc. from customers that the services provider has managed on behalf of the customers. For example, a customer may contract the services provider to pay property taxes for a portfolio of properties. All records, including tax bills, tax payments, etc. may be stored in database 36. In some embodiments, the historical database 36 may also include the results of assessing taxes associated with real estate properties by the services provider (discussed below).

As further shown in FIG. 1, the system 20 may also include one or more interfaces 40 to other (externally hosted) services and databases. For example, the system may include APIs or other interfaces for retrieving data from LexisNexis, Merlin, MERS, particular real estate companies, government agencies, and other types of entities.

As further shown in FIG. 1, the services applications 22 include a “property identification” application or application component 42 (hereinafter “application 42”). As explained below, this application or component 42 uses some or all of the data sources described above to identify to real estate properties and/or parcels for which data processing will be performed. As an example, such property identification information may be used for various tax-assessment-related or due diligence purposes. For example, a services provider may use such information to verify the accuracy of property identification information provided by a mortgage lender requesting tax services and/or to identify a property based on information provided by the mortgage lender.

The services applications 22 also include a “parcel identification” application or application component 44 (hereinafter “application 44”). As explained below, this application or component 44 uses some or all of the data sources described above and communicates with application 42 to identify data items, such as tax information, associated with real estate properties.

The services applications 22 further include a “parcel validation” application or application component 46 (hereinafter “application 46”). As explained below, this application or component 46 uses some or all of the data sources described above and communicates with application 42 to identify property information associated with government agency, such as tax, information.

### Example Parcel Identification Process

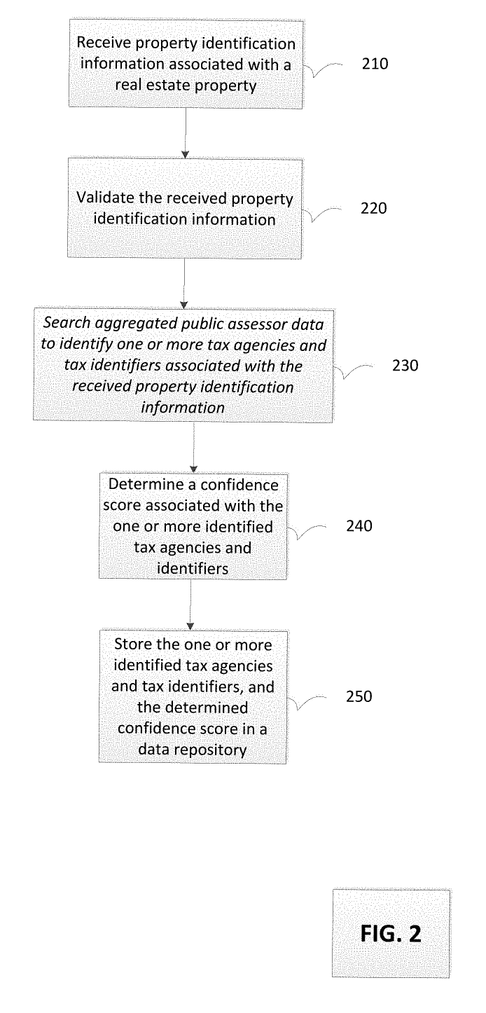

FIG. 2 illustrates one embodiment of an automated process that may be used by the parcel identification application or application component 44 to identify tax information associated with real estate properties. As depicted by block 210 of FIG. 2, the application 44 initially receives an identifier of a real estate property (e.g., address, latitude and/or longitude, parcel number, etc.) as submitted by the computing device 26 via the network 24. The user of computing device 26 may submit the identifier via a web page, a web services call, a mobile application, or any other appropriate interface. The submission may either be manual (e.g., a user submits a web form) or automated (e.g., a customer's computer system generates a web service or other type of call).

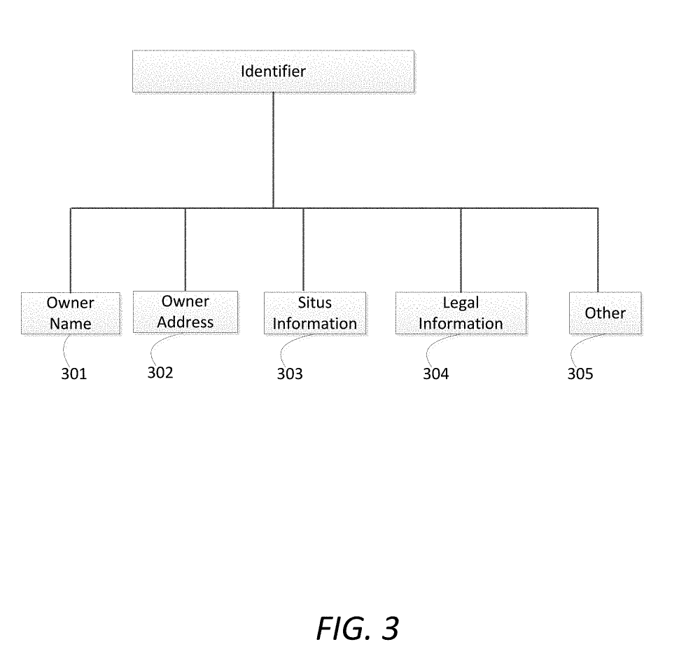

As shown in block 220 of FIG. 2, the application 44 then conducts a search for parcels and/or real estate properties associated with the received identifier to validate the received property identification information. This task validates that the received identifier is actually associated with parcels/real estate properties prior to performing any tax processing. In one embodiment, this task includes a search of the database of property data 30, aggregated public assessor data 32, and historical data 36 (FIG. 1). Application 44 communicates with application 42 to try to identify parcels and/or real estate properties associated with the received identifier. Application 42 can perform a search of the property database 30, aggregated assessor database 32, or historical database 36 using a matching algorithm to identify the associated parcels/real estate properties. The received identifier can include any information that could be used by application 42 to identify parcels or real estate properties. For example, the received identifier could include one or more of: address, owner/resident name, owner/resident address, legal description, longitude/latitude coordinates, parcel number, tax identifier, taxing authority, situs information, etc. FIG. 3 illustrates a variety of possible inputs associated with the received identifier that may be used by the matching process to identify the associated parcels real estate properties. As illustrated, the received identifier may comprise owner name 301, owner address 302, situs information 303, legal information 304, and other information 305 that can include additional data items, such as the items discussed above.

Application 42 may then perform a matching algorithm to try to identify parcels/real estate properties that are associated with the received identifier. Application 42 may perform the matching algorithm for each provided piece of identification information to obtain a list of potential matches and/or may apply the matching algorithm on a combination of the pieces of information. This list of potential matches may include multiple parcels/real estate properties because the received identifier may not uniquely match to a single parcel/real estate property. For example, if the received identifier only includes an owner name, then multiple parcels/real estate properties may be identified that have owners with similar names. The list of potential matches may be provided to computing device 26 for selection of the matches of interest. The matching algorithm, in some embodiments, may also provide a matching score associated with each provided piece of identification information. The match score can be an indicator of the strength of the match between the received identifier and the matched parcels/real estate properties. For instance, a respective matching score associated with the owner address and the legal description may be provided based on how similar the received owner address and legal description are to the owner name and legal description associated with each matched parcel/real estate property. In some embodiments, only identified parcels/real estate properties that have a match score over a predetermined match score threshold may be identified. In one embodiment, only the best matched parcel/real estate property may be identified.

In block 230 of FIG. 2, a search is conducted of the public assessor (tax roll) database 32 (FIG. 1) to identify one or more tax agencies and tax identifiers associated with the list of potential matches of parcels/real estate properties for the received identifier. Application 44 accesses aggregated public assessor database 32 to locate tax agencies that have assessed taxes or will assess taxes on the identified parcels/real estate properties. Application 44 then accesses aggregated public assessor database 32 to identify the tax identifier for the identified parcels/real estate properties from the located tax agencies. As used herein, tax identifier is an identifier used by a taxing agency to identify a property for tax collection purposes. In some embodiments, the tax identifier is different from Assessor's Parcel Number or APN. In some embodiments, a search may be conducted of the historical database 36 (FIG. 1) to identify the one or more tax agencies and tax identifiers associated with the list of potential matches of parcels/real estate properties for the received identifier. Application 44 accesses historical database 36 to locate tax agencies that have assessed taxes on the identified parcels/real estate properties. Application 44 may search historical tax bills, tax payments, customer contracts/requests, results of previous searches, etc. to locate the tax agencies that have assessed taxes on the identified parcels/real estate properties. Application 44 then accesses historical database 36 to identify the tax identifier for the identified parcels/real estate properties from the located tax agencies.

As depicted in block 240, a respective confidence score or error rate associated with the identified tax agencies and identifiers is determined. The confidence score or error rate may be determined by analyzing the received identifier information and/or the determined matching scores discussed above. If the received identifier information includes tax information, such as a tax agency identifier, tax identifier, etc., application 44 may determine a respective match score based on a comparison to the identified tax agencies and identifiers. Moreover, the respective match scores may be adjusted or weighted differently based on the source of the identified tax agencies and identifiers. For example, identified tax agencies/identifiers from the historical database 36 may be weighted higher because the data may include actual tax bills/payments, customer contracts, previous searches that may enhance the confidence in the identified tax agencies/identifiers. The generated match scores from the individual data items in the received identifier may also be processed, e.g., combined and/or mathematically manipulated into input features that will serve as input to the confidence scoring model in use. An example input feature may be the maximum of two or more match scores, e.g., max(match score 1, match score 2, . . . , match score n). Another example input feature may be the average of several match scores. In other embodiments, the match scores may be combined by a weighted average. Initial weights for each factor discussed above may be assigned at random or may represent estimations. Changing the weight of the various factors may then result in better or worse models. Such modeling may be done by a number of well-known methods such as through the use of neural networks, logistic regression and the like. The approach may also be hands-on with statisticians or others aiding the modeling process or automated, such as with back propagation in a neural network to improve modeling.

Subsequently, as depicted by block 250 of FIG. 2, the determined confidence score or error rate along with the identified tax agencies and identifiers may be stored in a data repository, such as historical database 36. In one embodiment, the logic and/or reasons supporting the determined confidence score may also be stored in the data repository. For example, the match scores, the confidence scoring model used, the weights applied, etc. may also be stored in the data repository linked to the confidence scores. In some embodiments, the determined confidence score or error rate along with the identified tax agencies and identifiers may be provided to computing device 26. In some embodiments, the determined confidence score or error rate along with the identified tax agencies and identifiers may be provided for further manual review.

### Example Parcel Validation Process

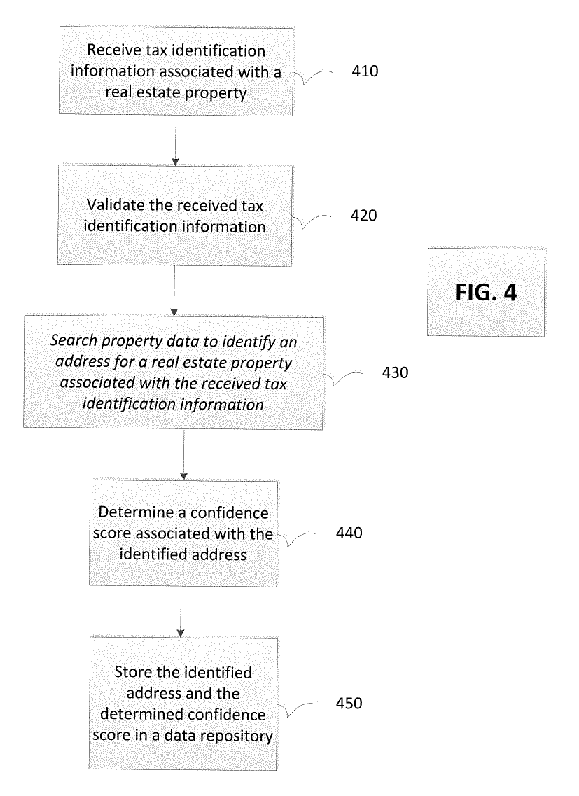

FIG. 4 illustrates one embodiment of an automated process that may be used by the parcel validation application or application component 46 to identify property information associated with real estate properties. As depicted by block 410 of FIG. 4, the application 46 initially receives tax identification information associated with a real estate property (e.g., tax agency, tax identifier, tax amount, etc.) as submitted by the computing device 26 via the network 24. The user of computing device 26 may submit the identification information via a web page, a web services call, a mobile application, or any other appropriate interface. The submission may either be manual (e.g., a user submits a web form) or automated (e.g., a customer's computer system generates a web service or other type of call).

As shown in block 420 of FIG. 4, the application 46 then conducts a search for tax information associated with the received tax identification information to validate the received tax identification information. This task validates that the received identification information is actually associated with tax information, such as agencies, identifiers, amounts, etc. prior to performing any further processing. In one embodiment, this task includes a search of the database of property data 30, aggregated public assessor data 32, and historical data 36 (FIG. 1). Application 46 communicates with application 42 to try to identify tax information associated with the received tax identification information. Application 42 can perform a search of the property database 30, aggregated assessor database 32, or historical database 36 using a matching algorithm to identify the associated tax information. The received identification information can include any tax information that could be used by application 42 to identify associated information. For example, the received identification information could include one or more of: tax identifier, taxing authority, tax amount, etc.

Application 42 may perform the matching algorithm for each provided piece of identification information to obtain a list of potential matches and/or may apply the matching algorithm on a combination of the pieces of information. This list of potential matches may include multiple tax information items because the received tax identification information may not uniquely match to a single tax information item. For example, if the received identification information only includes a taxing authority, then tax information items may be identified that are associated with the same authority. The list of potential matches may be provided to computing device 26 for selection of the matches of interest. The matching algorithm, in some embodiments, may also provide a matching score associated with each provided piece of identification information. The match score can be an indicator of the strength of the match between the received identification information and the matched tax information items. For instance, a respective matching score associated with the taxing authority and the tax identifier may be provided based on how similar the received taxing authority and tax identifier are to the taxing authority and tax identifier associated with each matched item. In some embodiments, only identified tax information items that have a match score over a predetermined match score threshold may be identified. In one embodiment, only the best matched tax information items may be identified.

In block 430 of FIG. 4, a search is conducted of the property database 30 (FIG. 1) to identify one or more addresses associated with parcels or real estate properties associated with the list of potential matches for the received tax identification information. Application 46 accesses property database 30 to locate addresses of the identified parcels/real estate properties. In some embodiments, a search may be conducted of the historical database 36 (FIG. 1) to identify one or more addresses associated with parcels or real estate properties associated with the list of potential matches for the received tax identification information. Application 44 accesses historical database 36 to locate addresses of parcels of real estate properties that tax agencies have assessed taxes on. Application 44 may search historical tax bills, tax payments, customer contracts/requests, results of previous searches, etc. to locate the addresses.

As depicted in block 440, a respective confidence score or error rate associated with the identified addresses determined. The confidence score or error rate may be determined by analyzing the received tax identification information and/or the determined matching scores discussed above. If the received identification information includes property information, such as an address, a gross living area, a county, etc., application 44 may determine a respective match score based on a comparison to the identified addresses. Moreover, the respective match scores may be adjusted or weighted differently based on the source of the identified addresses. For example, identified address from the historical database 36 may be weighted higher because the data may include actual tax bills/payments, customer contracts, previous searches that may enhance the confidence in the identified addresses. The generated match scores from the individual data items in the received identification information may also be processed, e.g., combined and/or mathematically manipulated into input features that will serve as input to the confidence scoring model in use. An example input feature may be the maximum of two or more match scores, e.g., max(match score 1, match score 2, . . . , match score n). Another example input feature may be the average of several match scores. In other embodiments, the match scores may be combined by a weighted average. Initial weights for each factor discussed above may be assigned at random or may represent estimations. Changing the weight of the various factors may then result in better or worse models. Such modeling may be done by a number of well-known methods such as through the use of neural networks, logistic regression and the like. The approach may also be hands-on with statisticians or others aiding the modeling process or automated, such as with back propagation in a neural network to improve modeling.

Subsequently, as depicted by block 450 of FIG. 4, the determined confidence score or error rate along with the identified addresses may be stored in a data repository, such as historical database 36. In one embodiment, the logic and/or reasons supporting the determined confidence score, as discussed above, may also be stored in the data repository linked to the confidence scores. In some embodiments, the determined confidence score or error ate along with the identified addresses may be provided to computing device 26. In some embodiments, the determined confidence score or error ate along with the identified tax addresses may be provided for further manual review.

### Example Automatic Parcel Identification Process

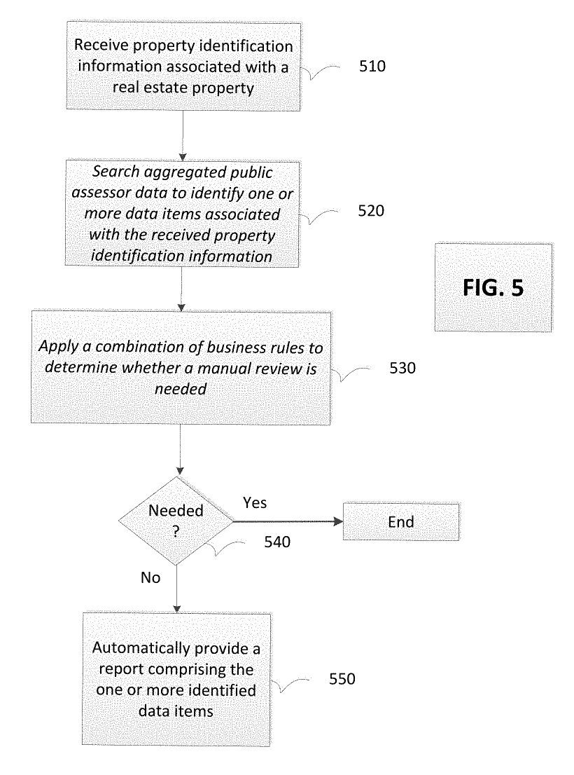

FIG. 5 illustrates one embodiment of an automated process that may be used by the parcel identification application or application component 44 to automatically identify tax information associated with real estate properties without substantial user interaction. As depicted by block 510 of FIG. 5, the application 44 initially receives a request comprising an identifier of a real estate property (e.g., address, latitude and/or longitude, parcel number, etc.) as submitted by the computing device 26 via the network 24. The user of computing device 26 may submit the identifier via a web page, a web services call, a mobile application, or any other appropriate interface. The submission may either be manual (e.g., a user submits a web form) or automated (e.g., a customer's computer system generates a web service or other type of call).

In block 520 of FIG. 5, a search is conducted of the public assessor (tax roll) database 32 (FIG. 1) to identify one or more data items associated with the received identifier. Application 44 accesses aggregated public assessor database 32 to locate the one or more data items. For example, a search may be conducted to locate tax agencies that have assessed taxes or will assess taxes on the identified property associated with the received identifier (see discussion above). In some embodiments, a search may be conducted of the historical database 36 (FIG. 1) to identify the one or more data items associated with the received identifier. For example, application 44 may search historical tax bills, tax payments, customer contracts/requests, results of previous searches, etc. to locate the tax agencies that have assessed taxes on the identified property associated with the received identifier.

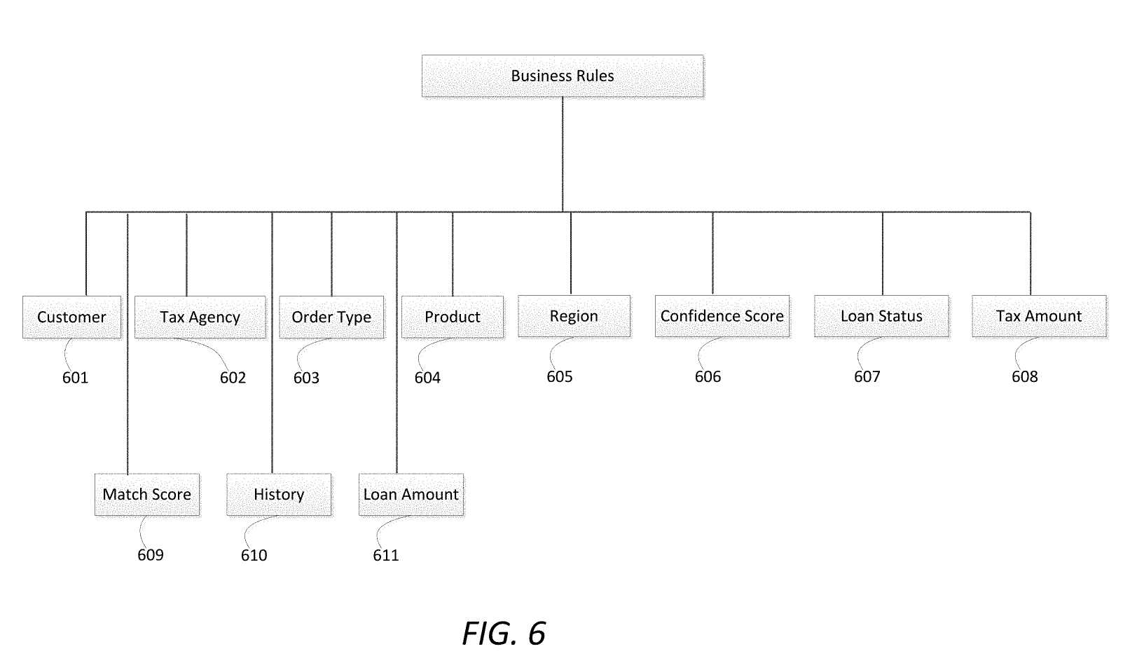

As depicted in block 530, a combination of business rules are then applied to determine whether a manual review is needed. The term “business rule” as used herein includes a statement that defines or indicates conditions or logic that are applied to one or more factors to determine the confidence in a determined result. By applying the business rules in combination to determine whether a manual review is needed, application 44 can determine whether the identified data items are sufficiently accurate for processing without substantial user interaction. That is, the determination may be an indicator of the confidence in the identified data items such that no further or no substantial user interaction may be needed. An advantage of this embodiment is that the human resources can be reduced and more robust and efficient data processing can be provided. In some embodiments, the one or more business rules may be dynamically configurable. For example, based on the effectives of the business rules, the business rules may be dynamically adjusted. As another example, customers, such as banks, mortgage lenders, insurance companies, etc. may provide business rules and updates to business rules that can be dynamically included in embodiments of the present invention. The customers in various embodiments may provide criteria that the services provider may use to generate business rules as needed. FIG. 6 illustrates a variety of factors that may be considered in constructing the one or more business rules in accordance with one embodiment. As illustrated, the one or more business rules may consider one or more factors associated with the request or search to determine whether a manual review is needed. The business rules can specify criteria associated with the factors that will need to be met in order to make a determination that a manual review is not needed. The factors and criteria may be configured based on review of historical processing, communications with search and processing experts, and/or user preferences. The factors, as illustrated may comprise, customer 601, tax agency 602, order type 603, product 604, region 605, confidence score 606, loan status 607, tax amount 608, match score 609, history 610, and tax amount 611. Each of these factors will be discussed further.

Application 44 may consider a business rule that considers the identity of the customer 601 or user making the request for processing. For example, a business rule may specify that for government customers, manual review is always needed. The business rule may be set to comply with government regulations for example. Application 44 may consider a business rule that considers the identity of the tax agency 602 identified during the search. For example, a business rule may specify that for a particular city taxing authority, manual review is needed. The business rule may be set based on previous searches of tax data associated with the city taxing authority and determination that the data is unreliable. Application 44 may consider a business rule that considers the order type 603 associated with the request. For example, a business rule may specify that requests for commercial properties, a manual review is needed. The business rule may be set based on previous searches of tax data associated with commercial properties or communications with experts, and a determination that identification of tax data for commercial properties is more complex and prone to errors. Application 44 may consider a business rule that considers the product 603 associated with the request. For example, a business rule may specify that for premium products or products in a specific family, a manual review is needed. The business rule may be set based on previous searches, user preferences, or communications with experts.

Moreover, application 44 may consider a business rule that considers the region 604 associated with the request or search. For example, a business rule may specify that for customers from a particular state, county, district, etc. or for properties located in a certain state, county, district, etc., a manual review is needed. The business rule may again be set based on previous searches, user preferences, or communications with experts. Application 44 may consider a business rule that considers the confidence score 606 associated with the search. As discussed above, in reference to FIG. 2, a confidence score associated with the search process may be determined. The value of the confidence score may be analyzed by a business rule to determine whether a manual search is needed. For example, a business rule may specify that for a search having a confidence score less than 75%, a manual review is needed. The business rule may be set based on previous searches or communications with experts, and a determination that confidence scores meeting certain threshold criteria were found to be sufficiently accurate that further manual review is not needed. Application 44 may consider a business rule that considers the loan status 607 associated with the search. For example, a business rule may specify that properties that have open loans with CLTV ratios of 50% or higher, a manual review is needed. The business rule may be set based on previous searches or communications with experts, and a determination that properties with loans having high CLTV ratios are of higher risk to customers, and therefore need further manual review.

Furthermore, application 44 may consider a business rule that considers the tax amount 608 associated with the search. For example, a business rule may specify that for tax information that is identified that has a tax amount over an acceptable threshold, such as $10,000, a manual search may be needed. To determine the threshold tax amount, in some embodiments, calculations can be made to account to the variance of tax amounts assessed by tax agencies. For example, historical data 36 may be analyzed to determine historical tax amounts from the tax agencies of interest. An average of the tax amounts may then be determined and a standard deviation may then be calculated for the tax amounts. Subsequently an adjustment factor may be calculated based on user preferences to account for the variance in the tax amounts. The adjustment factor can be configured to account for as many tax amounts desired by adjusting the threshold amount. The adjustment factor may be configured such that outlier tax amounts beyond the threshold amount may require further manual review. For example, one standard deviation may account for 68% of the tax amounts while 3 standard deviations may account for 99.7% of the tax amounts. One or more standard deviations can be calculated as the adjustment factor and added to the average for the tax amounts to determine the threshold tax amount. The business rule may be set based on previous searches, user preferences, or communications with experts, and a determination that properties with higher tax assessments are of higher value to customers, and therefore need further manual review. Application 44 may consider a business rule that considers the match score 608 associated with the search. As discussed above in reference to FIG. 2, match scores based on the received identifier and identified data items from the search may be determined. The value of the match score may be analyzed by a business rule to determine whether a manual search is needed. For example, a business rule may specify that for identified properties having match scores less than 80%, a manual review may be needed. The business rule may be set based on previous searches or communications with experts, and a determination that match scores meeting certain threshold criteria were found to be sufficiently accurate that further manual review is not needed. Application 44 may consider a business rule that considers the history 610 associated with the search. Application 44 may keep track of the success and/or accuracy of previous iterations of the business rules and consider the success and/or accuracy in configuring the business rules. Moreover, application 44 may consider a business rule that considers the loan amount 611 associated with the search. For example, a business rule may specify that properties that have open loans with amounts greater than $500,000, a manual review is needed. The business rule may be set based on previous searches or communications with experts, and a determination that properties with loans having high outstanding amounts are of higher risk to customers, and therefore need further manual review. A variety of other criteria and/or conditions may be used in consideration of the factors by the business rules. A variety of additional factors may also be considered in constructing the combination of business rules. In some embodiments, priorities and/or weights may be given to application of the business rules for determination of whether manual review is needed. For example, a high priority may be given to the business rule associated with the tax agency such that failure to meet the conditions of that rule requires manual review even if other business rules are satisfied. As another example, weights may be given to the combination of business rules and if application of the business rules with weights exceeds a certain threshold, then manual review may not be needed. In some embodiments, a business rule may be configured to consider multiple factors and/or a combination of factors. For instance, a business rule may be configured that requires a certain type of customer and a certain threshold for the tax amount. A variety of other configurations and combinations are possible in embodiments of the present invention.

Subsequently, as depicted by block 540 of FIG. 5, if it is determined that manual review is needed, the process ends. Application 44 may flag the search results for further manual review or may discard the results. In some embodiments, the results of the manual review may be compared to the one or more identified data items to identify the effectiveness of the automatic parcel identification process and to modify or update the automatic parcel identification process and/or business rules based at least in part on the effectiveness. If it is determined that further manual review is not needed, then, as illustrated by block 550, application 44 can automatically provide a report that comprises the one or more identified data items.

### Example Automatic Parcel Validation Process

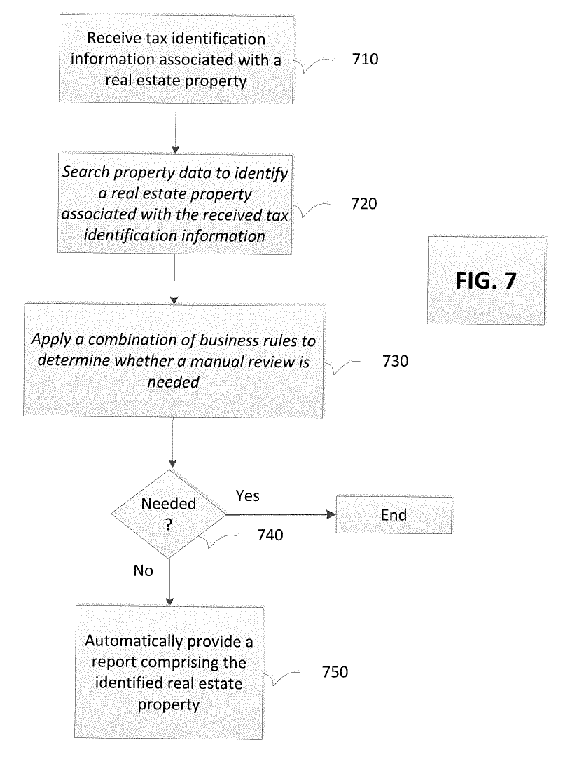

FIG. 7 illustrates one embodiment of an automated process that may be used by the parcel validation application or application component 46 to automatically identify property information associated with real estate properties. As depicted by block 710 of FIG. 7, the application 46 initially receives tax identification information associated with a real estate property (e.g., tax agency, tax identifier, tax amount, etc.) as submitted by the computing device 26 via the network 24. The user of computing device 26 may submit the identification information via a web page, a web services call, a mobile application, or any other appropriate interface. The submission may either be manual (e.g., a user submits a web form) or automated (e.g., a customer's computer system generates a web service or other type of call).

In block 720 of FIG. 7, a search is conducted of the property database 30 (FIG. 1) to identify one or more addresses associated with the received identifier. Application 46 accesses property database 30 to locate the one or more addresses. In some embodiments, a search may be conducted of the historical database 36 (FIG. 1) to identify one or more addresses associated with the received identifier. For example, application 44 may search historical tax bills, tax payments, customer contracts/requests, results of previous searches, etc. to locate the addresses.

As depicted in block 730, similar to the process discussed above, a combination of business rules are then applied to determine whether a manual review is needed. A variety of factors, such as those illustrated in FIG. 5, may be considered in configuring the combination of business rules.

Subsequently, as depicted by block 740 of FIG. 7, if it is determined that manual review is needed, the process ends. Application 46 may flag the search results for further manual review or may discard the results. In some embodiments, the results of the manual review may be compared to the one or more identified addresses to identify the effectiveness of the automatic parcel validation process and to modify or update the automatic parcel validation process and/or business rules based at least in part on the effectiveness. If it is determined that further manual review is not needed, then, as illustrated by block 750, application 46 can automatically provide a report that comprises the one or more identified addresses.

### Example Government Agencies Parcel Identification Process

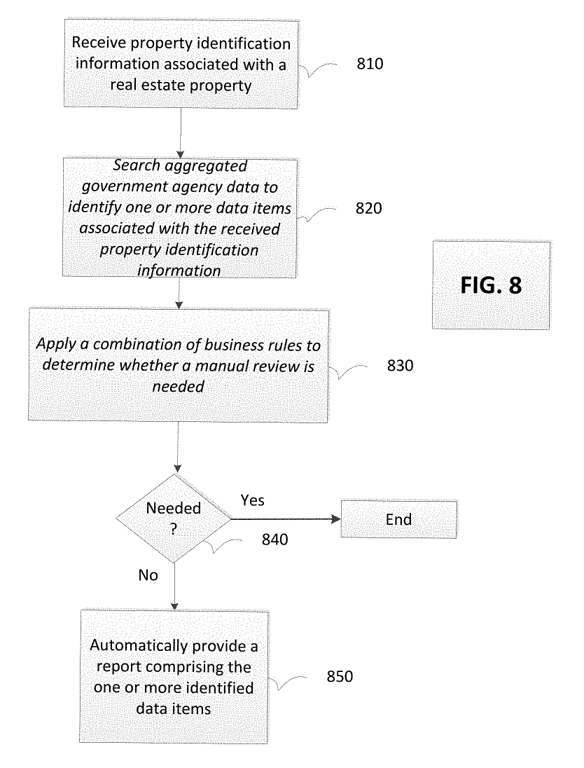

Implementations of the disclosed systems and methods were described in the context of tax processing for real estate properties. This was for purposes of illustration and is not a limitation. For example, implementations of the disclosed systems and methods can be used for any type of data that is collected from government agencies. For example, FIG. 8 illustrates the parcel identification process for any type of data from a government agency. FIG. 8 illustrates one embodiment of an automated process that may be used by the parcel identification application or application component 44 to automatically identify government agency information associated with real estate properties without substantial user interaction. As depicted by block 810 of FIG. 8, the application 44 initially receives a request comprising an identifier of a real estate property (e.g., address, latitude and/or longitude, parcel number, etc.) as submitted by the computing device 26 via the network 24. The user of computing device 26 may submit the identifier via a web page, a web services call, a mobile application, or any other appropriate interface. The submission may either be manual (e.g., a user submits a web form) or automated (e.g., a customer's computer system generates a web service or other type of call).

In block 820 of FIG. 8, a search is conducted of aggregated government agency database 34 to identify one or more data items associated with the received identifier. Application 44 accesses the aggregated government agency database 34 to locate the one or more data items. In some embodiments, a search may be conducted of the historical database 36 (FIG. 1) to identify the one or more data items associated with the received identifier.

As depicted in block 830, similar to the process discussed above, a combination of business rules are then applied to determine whether a manual review is needed. A variety of factors, such as those illustrated in FIG. 5, may be considered in configuring the combination of business rules. The combination of business rules, as discussed above, may be configured based on communications with experts, user preferences, previous results, etc.

Subsequently, as depicted by block 840 of FIG. 8, if it is determined that manual review is needed, the process ends. Application 44 may flag the search results for further manual review or may discard the results. In some embodiments, the results of the manual review may be compared to the one or more identified data items to identify the effectiveness of the government agencies parcel identification process and to modify or update the government agencies parcel identification process and/or business rules based at least in part on the effectiveness. If it is determined that further manual review is not needed, then, as illustrated by block 850, application 44 can automatically provide a report that comprises the one or more identified data items.

### Example Government Agencies Parcel Validation Process

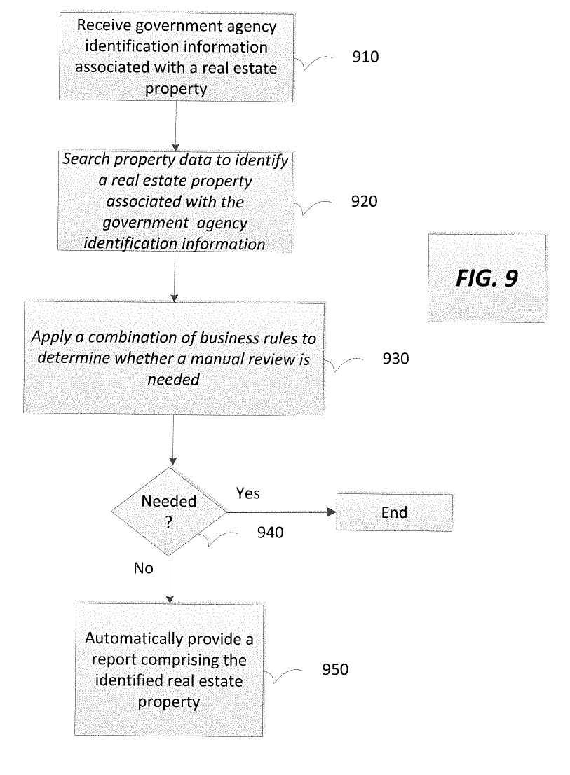

FIG. 9 illustrates one embodiment of an automated process that may be used by the parcel validation application or application component 46 to automatically identify property information associated with any type of data from a government agency related to real estate properties. As depicted by block 910 of FIG. 9, the application 46 initially receives government agency identification information associated with a real estate property, as submitted by the computing device 26 via the network 24. The user of computing device 26 may submit the identification information via a web page, a web services call, a mobile application, or any other appropriate interface. The submission may either be manual (e.g., a user submits a web form) or automated (e.g., a customer's computer system generates a web service or other type of call).

In block 920 of FIG. 9, a search is conducted of the property database 30 (FIG. 1) to identify one or more addresses associated with the received identifier. Application 46 accesses property database 30 to locate the one or more addresses. In some embodiments, a search may be conducted of the historical database 36 (FIG. 1) to identify one or more addresses associated with the received identifier.

As depicted in block 930, similar to the process discussed above, a combination of business rules are then applied to determine whether a manual review is needed. A variety of factors, such as those illustrated in FIG. 5, may be considered in configuring the combination of business rules. The combination of business rules, as discussed above, may be configured based on communications with experts, user preferences, previous results, etc.

Subsequently, as depicted by block 940 of FIG. 9, if it is determined that manual review is needed, the process ends. Application 46 may flag the search results for further manual review or may discard the results. In some embodiments, the results of the manual review may be compared to the one or more identified addresses to identify the effectiveness of the government agencies parcel validation process and to modify or update the government agencies parcel validation process and/or business rules based at least in part on the effectiveness. If it is determined that further manual review is not needed, then, as illustrated by block 950, application 46 can automatically provide a report that comprises the one or more identified addresses.

### CONCLUSION

All of the methods and tasks described herein may be performed and fully automated by a computer system. The computer system may, in some cases, include multiple distinct computers or computing devices (e.g., physical servers, workstations, storage arrays, etc.) that communicate and interoperate over a network to perform the described functions. Each such computing device typically includes a processor (or multiple processors) that executes program instructions or modules stored in a memory or other non-transitory computer-readable storage medium or device. The various functions disclosed herein may be embodied in such program instructions, although some or all of the disclosed functions may alternatively be implemented in application-specific circuitry (e.g., ASICs or FPGAs) of the computer system. Where the computer system includes multiple computing devices, these devices may, but need not, be co-located, and may be cloud-based devices that are assigned dynamically to particular tasks. The results of the disclosed methods and tasks may be persistently stored by transforming physical storage devices, such as solid state memory chips and/or magnetic disks, into a different state.

The methods and processes described above may be embodied in, and fully automated via, software code modules executed by one or more general purpose computers. The code modules, such as application 42, application 44, and application 46, may be stored in any type of computer-readable medium or other computer storage device. Some or all of the methods may alternatively be embodied in specialized computer hardware. Code modules or any type of data may be stored on any type of non-transitory computer-readable medium, such as physical computer storage including hard drives, solid state memory, random access memory (RAM), read only memory (ROM), optical disc, volatile or non-volatile storage, combinations of the same and/or the like. The methods and modules (or data) may also be transmitted as generated data signals (e.g., as part of a carrier wave or other analog or digital propagated signal) on a variety of computer-readable transmission mediums, including wireless-based and wired/cable-based mediums, and may take a variety of forms (e.g., as part of a single or multiplexed analog signal, or as multiple discrete digital packets or frames). The results of the disclosed methods may be stored in any type of non-transitory computer data repository, such as databases 30 and 32, relational databases and flat file systems that use magnetic disk storage and/or solid state RAM. Some or all of the components shown in FIG. 1, such as those that are part of the Services System, may be implemented in a cloud computing system.

Further, certain implementations of the functionality of the present disclosure are sufficiently mathematically, computationally, or technically complex that application-specific hardware or one or more physical computing devices (utilizing appropriate executable instructions) may be necessary to perform the functionality, for example, due to the volume or complexity of the calculations involved or to provide results substantially in real-time.

Any processes, blocks, states, steps, or functionalities in flow diagrams described herein and/or depicted in the attached figures should be understood as potentially representing code modules, segments, or portions of code which include one or more executable instructions for implementing specific functions (e.g., logical or arithmetical) or steps in the process. The various processes, blocks, states, steps, or functionalities can be combined, rearranged, added to, deleted from, modified, or otherwise changed from the illustrative examples provided herein. In some embodiments, additional or different computing systems or code modules may perform some or all of the functionalities described herein. The methods and processes described herein are also not limited to any particular sequence, and the blocks, steps, or states relating thereto can be performed in other sequences that are appropriate, for example, in serial, in parallel, or in some other manner. Tasks or events may be added to or removed from the disclosed example embodiments. Moreover, the separation of various system components in the implementations described herein is for illustrative purposes and should not be understood as requiring such separation in all implementations. It should be understood that the described program components, methods, and systems can generally be integrated together in a single computer product or packaged into multiple computer products. Many implementation variations are possible.

The processes, methods, and systems may be implemented in a network (or distributed) computing environment. Network environments include enterprise-wide computer networks, intranets, local area networks (LAN), wide area networks (WAN), personal area networks (PAN), cloud computing networks, crowd-sourced computing networks, the Internet, and the World Wide Web. The network may be a wired or a wireless network or any other type of communication network.

The various elements, features and processes described herein may be used independently of one another, or may be combined in various ways. All possible combinations and subcombinations are intended to fall within the scope of this disclosure. Further, nothing in the foregoing description is intended to imply that any particular feature, element, component, characteristic, step, module, method, process, task, or block is necessary or indispensable. The example systems and components described herein may be configured differently than described. For example, elements or components may be added to, removed from, or rearranged compared to the disclosed examples.

As used herein any reference to “one embodiment” or “some embodiments” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. In addition, the articles “a” and “an” as used in this application and the appended claims are to be construed to mean “one or more” or “at least one” unless specified otherwise.

As used herein, the terms “comprises,” “comprising,” “includes,” “including,” “has,” “having” or any other variation thereof, are open-ended terms and intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y and at least one of Z to each be present.

The foregoing disclosure, for purpose of explanation, has been described with reference to specific embodiments, applications, and use cases. However, the illustrative discussions herein are not intended to be exhaustive or to limit the inventions to the precise forms disclosed Many modifications and variations are possible in view of the above teachings. The embodiments were chosen and described in order to explain the principles of the inventions and their practical applications, to thereby enable others skilled in the art to utilize the inventions and various embodiments with various modifications as are suited to the particular use contemplated.

1-20. (canceled)

21. A computing system comprising one or more computing devices programmed with executable program code, the executable program code comprising:
a first application component configured to process a data submission that comprises multiple elements of information associated with real estate, said data submission received over a network through a data submission interface; and
a second application component that communicates with the first application component, the second application component configured to apply a matching algorithm that matches elements of information to real estate properties represented in a database;
wherein the first application component is configured to process the data submission by at least:
using the second application component to validate that the data submission corresponds to a real estate property;
identifying one or more tax authorities associated with the real estate property at least partly by executing a search of aggregated public assessor data, the aggregated public assessor data obtained from a plurality of public assessor entities and converted to a standard format; and
generating a respective confidence score for each of the one or more identified tax authorities.

22. The system of claim 21, wherein the second application component is configured to generate match scores for each of the multiple elements of information, and to use the match scores to attempt to identify a single real estate property corresponding to the data submission.

23. The system of claim 22, wherein the second application component is configured to use the match scores in combination to determine a degree of match between the submission and a candidate property.

24. The system of claim 21, wherein the first application component, in identifying one or more tax authorities associated with the real estate property, is additionally configured to execute a search of historical transaction data, said historical transaction data obtained from a plurality of public recorders offices and converted into a standard format.

25. The system of claim 21, wherein the submission comprises an address associated with the real estate property.

26. The system of claim 21, wherein the first application component is configured to determine, based at least partly on the one or more confidence scores, whether to flag a result of the search for human review.

27. The system of claim 21, wherein the second application component uses the matching algorithm to match the elements of information to property data obtained from data sources other than the public assessor entities.

28. The system of claim 21, wherein the second application component is configured to generate a weighted average of the match scores using weights that correspond to reliability levels of data sources of property data to which respective elements of information are matched.
